(19) United States
(12) Patent Application Publication
(10) Pub. No.: US 2020/0180179 A1
(43) Pub. Date: Jun. 11, 2020

(54) SAFETY RAZOR

(71) Applicant: BEIERSDORF AKTIENGESELLSCHAFT, Hamburg (DE)

(72) Inventors: Peter MAURER, Neumuenster (DE); Alexander KRUEMKE, Hamburg (DE); Michaela KOHUT, Hamburg (DE); Arne SCHULTCHEN, Hamburg (DE); Andre FELDMANN, Hamburg (DE); Christine JUNG, Hamburg (DE); Armin WARNECKE, Hamburg (DE)

(21) Appl. No.: 16/631,569

(22) PCT Filed: Jul. 16, 2018
(86) PCT No.: PCT/EP2018/069314

§ 371 Date: Jan. 16, 2020

(30) Foreign Application Priority Data
Jul. 17, 2017 (DE) 10 2017 116 063.9
Mar. 13, 2018 (DE) 10 2018 105 820.9

(51) Int. Cl. B26B 21/52

(52) U.S. Cl. CPC B26B 21/522

(57) ABSTRACT

A safety razor handle comprising: a handle body (50) and a cartridge attachment means (59); wherein the handle body is bulbous in two orthogonal directions, widening away from an end surface (52) towards the centre of the body.

### FIELD

Embodiments described herein relate to a safety razor and to a handle for a safety razor.

### BACKGROUND

Safety razors are typically composed of a blade unit (or cartridge) connected, either detachably or fixedly (permanently fixed or integrated), to a handle. A safety razor with a detachable and disposable cartridge is known as a safety razor system. Cartridges are known which have one or more parallel blades perpendicular to the shaving direction and thus to the handle, each defining a cutting edge, with cartridge elements positioned in front of and behind (rear of) the cutting edge(s) (referred to as a “guard” and a “cap”, respectively) in a shaving direction. A shaving aid, such as a thin lubricating strip, or lubrapad is often incorporated into one or both of these cartridge elements to improve shaving performance and lubricating treatment of the user's skin. Typically, the handle is elongate extending essentially in the direction of shaving. It would be desirable to provide an alternative handle design.

### BRIEF SUMMARY

Embodiments of the invention provide a safety razor handle comprising: a handle body and a cartridge attachment means; wherein the handle body is bulbous in two orthogonal directions, widening away from an end surface towards the centre of the body.

Thus an outline/silhouette of the handle body in both these directions may be generally fat and round. This “chunky” bulbous shapes of the handle allows a particularly flexible ergonomic handling, giving many varied gripping positions for the human hand and easy twisting of the handle within the grip to reach different angles.

Prior art razor safety razor handles have been elongate as a rule, but the embodiments are not elongate. Some compact (and therefore non-elongate) razors are available on the market, but they can be difficult for the user to manoeuvre, due to a thin depth of the handle.

The handle body may comprise a further end surface opposite to the end surface. The two opposite surfaces may be connected by a side surface which widens towards the centre (or approximate centre) of the body. The opposite further end surface gives an even better handling feel, particularly if there are opposite flat surface.

Of course, the handle body may widen away from the end surface not just in two orthogonal directions but in many or all of the directions in between these two orthogonal directions, so that the increase in size is general and thus of most of or the entire cross section. The side surface may be a single continuous curved side surface. This curved side surface, or a plurality of curved side surface portions, may provide the handle body with a cross section that increases continuously (without decreasing) away from the flat end surfaces towards the centre of the body, forming the bulbous shape mentioned above.

The further end surface may be a front end surface. This surface thus forms the front of the razor in use, facing in the opposite direction to the shaving direction. Correspondingly, the end surface may be a rear end surface facing in the shaving direction in use. The cartridge attachment means may be on the side surface, for example closer to the front end surface than to the rear end surface.

In use, the safety razor is pulled backwards across the skin in the shaving direction. The end surface may therefore be in front of the blades in the shaving direction (to the rear of the razor if the cartridge is seen as the front), and the further end surface behind the blades in the shaving direction (to the front of the razor).

As mentioned above, one or both end surfaces may be flat. The flat end surfaces may be parallel, providing a symmetrical feel which gives the user a better tactile impression of the overall handle, for improved shaving experience. One or both of the flat end surface(s) may be circular or elliptical, for example.

In one embodiment of a safety razor handle, the handle body is in the form of a slanted barrel shape, with a skewed barrel surface between two end surfaces, The barrel shape may be terminated at either end with a slanted end surface, which is not orthogonal to the barrel axis. Neither is the barrel shape itself necessarily formed from a circle of varying diameter extruded along a central straight axis. Rather, the handle body as a whole may be viewed as having a skewed barrel shape (potentially with a curved barrel axis).

When the two parallel end surfaces are in a vertical orientation, with the cartridge attachment extending downwards, the barrel surface may be skewed/slanted upwards from the front end surface towards the rear end surface.

If the cartridge attachment projects from the side surface and parallel to the end surface, then a slanted/overhang design of the handle (with the end surface(s) extending at a slant (non-perpendicular angle) to the average direction of the side surface between the centres of the two end surfaces) allows the handle body to sit with the rear end surface at the back of the user's hand grip on or towards the palm of the hand, with the user's fingers positioned on the front end surface and side surface. In this position the end surfaces slope up and back towards the user's hand, allowing a better view of the cartridge.

The barrel shape may have a substantially circular or substantially elliptical cross section perpendicular to its longitudinal axis (which may be straight or curved). The barrel shape may widen continuously from the two end surfaces towards the centre.

The handle body is not elongate. For example, the largest diameter of the barrel shape (which may be central along its axis) may be between a third and three times the length of the longitudinal axis of the barrel, preferably between a half and twice. The largest diameter of the barrel shape may be larger than the length of its longitudinal axis.

Any connection between the cartridge and the handle body may be used. For example, a part of the cartridge may simply fit into a recess in the handle body, or structure which is part of the handle may be provided outside or inside the handle body for attachment of the cartridge. This structure may be on (and/or inside) the side surface, or on (and/or inside) the flat end surface and the side surface.

The cartridge attachment means may be in the form of a stem which connects the cartridge and the handle body. This stem may extend from the side surface.

In a safety razor system, a part or all of the stem may be permanently attached to the handle body and a part or all of the stem may be permanently attached to the cartridge. For example, there may be a handle stem and a cartridge stem which are releasably attached together. The handle stem may extend into the cartridge stem when the two are attached or vice versa to provide a connection.

The end surface may be provided with a recess or other interface allowing attachment to another part, such as packaging or a travelling case, or suspension from a hook (which could be provided separately) on a wall or other vertical surface.

The handle body may be made of a single part and material (excluding any minor additions of logos etc). In one embodiment it is made of two or more parts, such as a core and an external layer, or two opposite halves, which are fabricated individually, and then connected. The stem may also be connected to form the full body at the same stage.

The stem and part of the handle body may fabricated from one part, for example to include a cartridge release mechanism and the rest of the handle body may fabricated from another part, possibly a translucent part.

In some embodiments, the handle body includes an insert inside a translucent material of the handle body. This insert may be used to permanently and attractively display a logo.

The handle body may have any suitable construction. The handle body may comprise a single material or may comprise a core material and an outer material. Inserts may be made in the same material or one or more different materials. In one embodiment the handle body is solid or contains a hard core or hard hollow core. This may allow the use of a softer material for the rest of the body.

In one embodiment, the handle body comprises a single moulded translucent or transparent body (forming a core or hollow core, an outer layer or the full body) of elastomeric material such as silicone, TPU (thermoplastic polyurethane), TPE (thermoplastic elastomer) PETG (Polyethylene Terephthalate Glycol), TPS or rubber (such as liquid silicone rubber or compression silicone rubber) for example having a Shore A hardness of around 5 to 80, preferably a squeezable 20 Shore A under the ASTM D2240-00 testing standard.

As used herein, TPEs are thermoplastic elastomers, for example thermoplastic elastomers selected from the group of styrenic block copolymers (TPE-s including TPE SBS and the hydrogenated version of TPE-SEBS; e.g. Thermoplast K, Thermolast M, Sofprene, or Laprene), thermoplastic olefins (TPE-o; e.g. For-Tec E), elastomeric alloys (TPE-v or TPV; e.g. Thermolast A, Thermolast V, Hipex, Forprene, Termoton-V, or Vegaprene), thermoplastic polyurethanes (TPU; e.g. Copec), thermoplastic copolyesters (TPE-E), thermoplastic polyamides and mixtures thereof.

As used herein, silicones (or polysiloxanes) are polymers that include any inert, synthetic compound made up of repeating units of siloxane.

These materials give a superior tactile feeling with a material that is soft and yet strong due to the shape of the handle. Moreover, the body being translucent or transparent allows the user to gain a better feel of the positioning of the handle (and thus of the attached blade unit) with respect to the hand and to the skin to be shaved.

The stem/attachment to the cartridge may be fabricated separately, from PPA Polyphthalamide)(/PPS (Polyphenylene sulphide)/LCP (Liquid Crystal Polymer) or ABS (Acrylonitrile Butadiene Styrene). The material may have a glass filling of 0% up to 40%, or 10% to 30%, preferably around 20%.

The materials and/or fabrication process may be chosen in such a way that the insert and core material will chemically bond with the handle material.

In one embodiment, the handle body is made entirely from a soft transparent silicon and the insert forming the stem is made from PPA (Polyphthalamide) with 20% glass filling. In another embodiment, the handle body is made entirely from a soft transparent TPE (thermoplastic elastomer) and the insert is made from PP (polypropylene) with 20% glass filling. In another embodiment, a handle body external portion is made from a soft transparent TPE (thermoplastic elastomer) and a handle body core and the stem are formed together from a thermoplastic.

A further embodiment relates to the handle and an attached cartridge. According to this further embodiment there is provided a safety razor comprising a safety razor handle as previously described and a cartridge. For example, there may be provided a safety razor comprising a safety razor handle and a cartridge, the safety razor having: a handle body and a cartridge attachment means; wherein the handle body is bulbous in two orthogonal directions, widening away from an end surface towards the centre of the body.

The above indicated aspects and embodiments may be combined with each other to achieve the advantageous effects as described above. Further embodiments, features, and advantages of the invention, as well as the structure and operation of the various embodiments of the invention are described in detail below with reference to the accompanying drawings.

### DESCRIPTION OF FIGURES

The accompanying drawings, which are incorporated herein and form a part of the specification, illustrate the present invention and, together with the description, further serve to explain the principles of the invention and to enable a person skilled in the pertinent art to make and use the invention.

Reference will now be made to FIGS. 1 to 34, in which:

FIG. 1 is a side view of a safety razor standing upright on its flat end surface on a horizontal plane;

FIG. 2 is a side view of the safety razor shown in FIG. 1 in a use position;

FIG. 3 is a front view of the safety razor shown in FIG. 1 in a use position;

FIG. 4 is a perspective view from the side and underneath of the safety razor shown in FIG. 1 in an upright position;

FIG. 5 is a perspective view from directly underneath of the safety razor shown in FIG. 1 in an upright position;

FIG. 6 is a perspective front view from above of the safety razor shown in FIG. 1 in a use position;

FIG. 7 is a perspective side view from above of the safety razor shown in FIG. 1 in a use position;

FIG. 8 is a photograph in side view of a safety razor in a use position;

FIGS. 9a to 9c show the safety razor of FIG. 1 with preferable dimensions;

FIG. 10 is a perspective in-use view of a handle and cartridge with a lubrapad from the top side (user side);

FIG. 11 is a side view of the handle and cartridge with lubrapad of FIG. 10;

FIG. 12 is another perspective view of the handle, blade unit and lubrapad of FIG. 10, but from the front;

FIG. 13 is another perspective view of the handle and cartridge with lubrapad of FIG. 10, but from underneath (skin side);

FIG. 14 is a front view from underneath of the handle and cartridge with lubrapad of FIG. 10;

FIG. 15 is a rear view of the handle and blade unit with lubrapad of FIG. 10;

FIG. 16 is a perspective view of a handle and cartridge in a use position with lubrapad demonstrating the translucent material of the handle;

FIG. 17 is a view of a cartridge and lubrapad from underneath, in a disassembled state;

FIG. 18 is a perspective view of a safety razor in a use position, the razor including a hard shell of the handle, from the front/top side;

FIG. 19 is a side section view of the razor of FIG. 18;

FIG. 20 is a perspective view from two angles of a disassembled safety razor system including a handle made up of a disassembled hard shell and body;

FIG. 21 is a perspective view of a safety razor in use under the arm;

FIG. 22 is a perspective view of a safety razor in use on the shin;

FIGS. 23a to 23h show alternative conceptual shapes of a safety razor;

FIGS. 23i and 23j show a razor in use under the arm;

FIG. 23k shows a razor position in the hand; FIG. 24 shows a translucent safety razor handle in perspective view;

FIG. 25a shows a safety razor in the upright position with a slanted construction and

FIG. 25b shows a safety razor in the upright position with a slanted construction but a lesser slant than in FIG. 25a;

FIG. 26a shows a safety razor in cross section in the upright position with a slanted construction and FIG. 26b shows a safety razor in cross section in the upright position with a slanted construction but a reduced density/specific weight area in the front of the razor compared to FIG. 26a;

FIG. 27a shows a safety razor in the upright position with a slanted construction and

FIG. 27b shows a safety razor in the upright position with a slanted construction and a shorter cartridge neck/stem than in FIG. 27a;

FIG. 28a shows a safety razor in cross section in the upright position with a slanted construction and FIG. 28b shows a safety razor in cross section in the upright position with a slanted construction and an anti-tipping detail;

FIG. 29a shows a safety razor in cross section in the upright position with a slanted construction and FIG. 29b shows a hollow safety razor in cross section in the upright position with a slanted construction and a suction feature;

FIG. 30a shows a safety razor in cross section in a hanging position with the (rear) end surface vertical and suspended from a knob on a vertical plane. FIG. 30b shows the safety razor and knob separately;

FIGS. 31a, 31b and 31c show three different cross sections of a handle in a use position with the same external shape made by three different manufacturing options;

FIGS. 32a, 32b and 32c show three different cross sections of a handle in a use position with the same external shape made with three different inserts;

FIG. 33 shows a side view of a safety razor in a use position with shaping and an core shown in dashed lines; and

FIGS. 34a, 34b and 34c are schematic diagrams of safety razors in side view showing options for embedding logos.

### DETAILED DESCRIPTION

The following detailed description refers to the accompanying drawings that illustrate examples and embodiments consistent with this invention. Other embodiments are possible, and modifications can be made to the embodiments within the spirit and scope of the invention. Therefore, the detailed description is not meant to limit the invention.

The term “underneath” is used to describe features of the handle, cartridge or a lubrapad that are positioned on the skin-contacting side of the cartridge or lubrapad (Le., on a shaving-side or underneath of the handle, cartridge or lubrapad) in use, and the term “top” is used to describe features of the handle, cartridge or lubrapad that are positioned on a side opposite the skin-contacting side of the cartridge or lubrapad in use (i.e., on a user side or on top of the cartridge or lubrapad). The terms “front”, “rear”, and “side(s)” are used herein with reference to the shaving direction, i.e., the direction in which the cartridge and lubrapad are intended to be moved during shaving. In particular, the term “front” means facing in the shaving direction, “rear” means facing in the opposite direction to the shaving direction, and “side(s)” mean to either side in the shaving direction. In general, the cartridge is positioned at the front of the razor in use and the razor is pulled backwards across the skin (with the cartridge last).

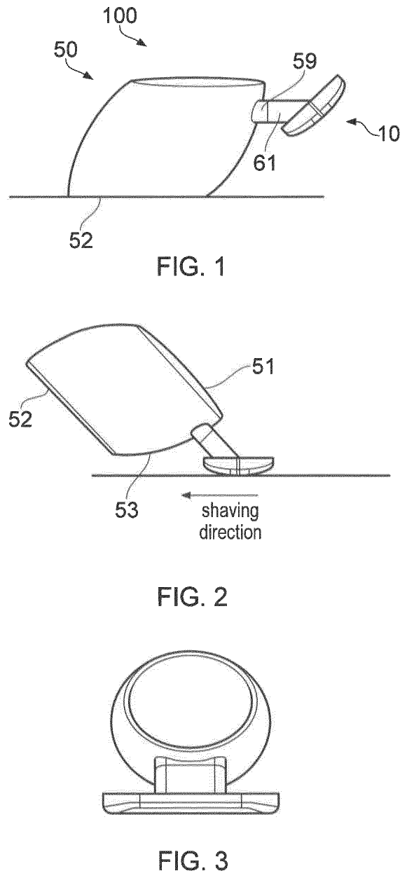

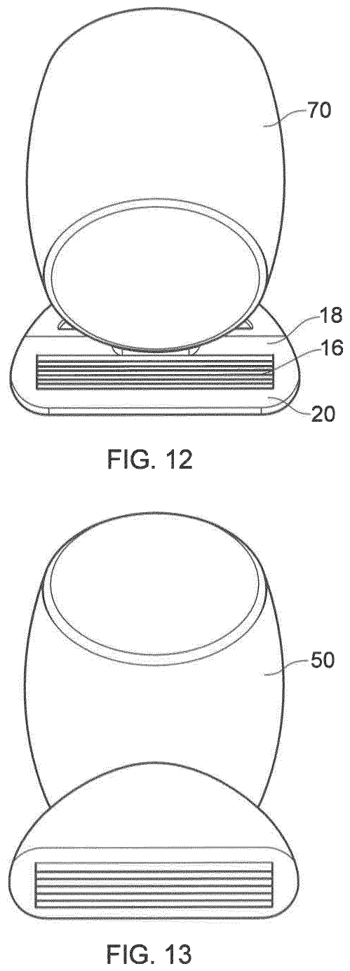

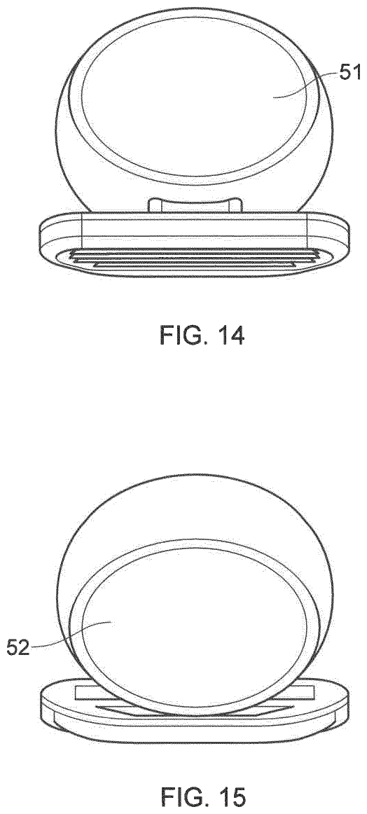

Reference will now be made to FIGS. 1 to 34, which are views of a cartridge 10 and handle body 50 joined by a stem 59, 61. Generally speaking, the described embodiments can be differentiated from one another in terms of the handle body 50, which can be of different shapes and constructions and the connection of the handle to the cartridge.

FIGS. 1 to 9 show different views of a handle body 50 of rounded, chunky design attached to a cartridge 10.

The handle body has a flat end surface 52 on which it can rest stably upright on a (substantially) horizontal surface, as shown in FIG. 1. In this orientation, the flat end surface rests on the horizontal plane and thus forms an underneath surface, and the further end surface forms a top surface of the razor. Here, the in-use definitions of directions set out for the general case above do not apply. The handle includes the handle body and a handle stem or cartridge attachment means 59. When the handle body is upright in its position of rest on a plane, the attachment means 59 which is provided on the side surface of the handle body towards the top surface is elevated above the plane. This elevates the cartridge itself above the plane, since the lowest point of the cartridge (the guard) is only slightly below the attachment means.

When the razor is in use, the flat end surface forms the rear surface of the razor, as shown in FIG. 2.

Opposite to the flat end surface is a further flat end surface 51. This is a front surface portion when the razor is in use, as shown in FIG. 2, and in the upright resting position is at the top, as previously mentioned. Any of the surfaces of the handle body, but particularly the front surface in use may be provided with information, logos, or other signs and patterns. Such a logo, for example, may have a different surface texture (gloss or matt or rough, for example) from the surrounding material, be protruded or recessed from the surrounding material or have a combination of finish and relief. If the handle body is made from more than one material, the combination of materials (for example using cut-outs or embossing) may be used to distinguish the logo.

These two opposite surfaces are parallel, and are separated by a single continuous side surface 56. As can be seen clearly from FIG. 6, this side surface is approximately barrel-shaped and bulbous, with a chunky form that expands from the end surfaces towards the centre of the handle body. The barrel shape is terminated at either end with a slanted end surface, which is not orthogonal to the barrel axis. Neither is the barrel shape itself formed from a circle of varying diameter extruded along a central straight axis. Rather, the handle body as a whole may be viewed as having a skewed barrel shape (with a curved barrel axis as shown in FIG. 1). The skewed barrel shape gives a visual effect, for example, of a deformed barrel shape which is produced when a flexible, “jelly” material attached on its circular barrel end surface to a horizontal supporting plane is skewed laterally and parallel to the end surface by movement of the top (or further end) surface.

The side surface of the handle body 56 has a curved underneath portion 53, a curved top portion 54 and curved lateral portions 55 in use as shown in FIGS. 5 and 6. A handle stem 59 extends from the curved underneath portion of the handle body parallel to the end surfaces. The curved surface portions together form a continuous smooth curved surface which is substantially circular or ellipsoid in cross section, but may vary in shape and size along its length between the front and rear of the handle.

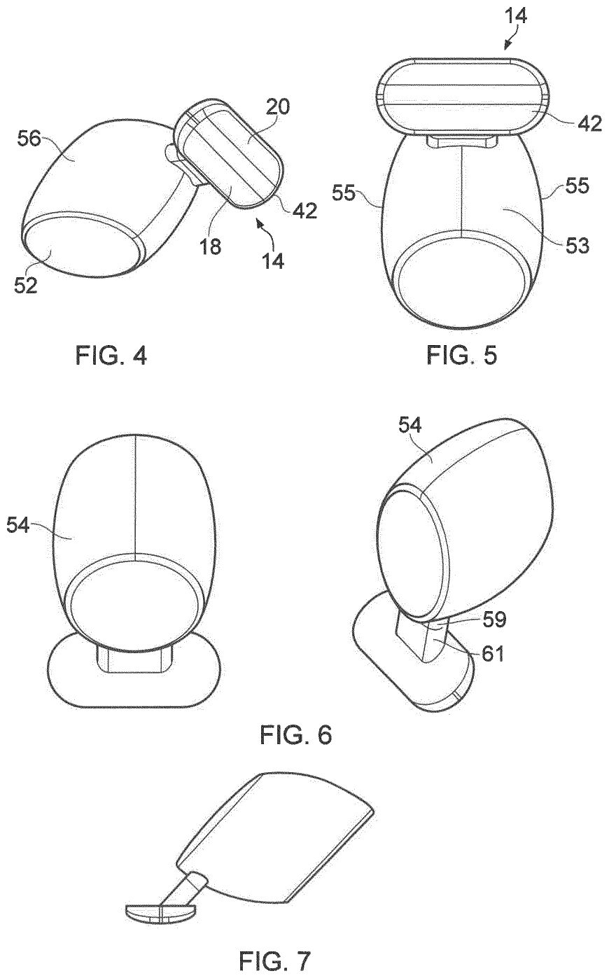

As shown best in FIG. 4, the cartridge 10 includes a guard 18, a cap 20, and rounded side portions 42 that together define a blade housing 14 within which a plurality of blades 16 (not shown) are disposed. The number of blades 16 can be, for example, four or five, though it can be fewer or more than this. The guard 18 is in front of the blades 16 in the shaving direction and the cap 20 is to the rear of the blades 16. The cartridge 10 can be connected to the handle body 50, either fixedly or detachably by connection between the handle stem 59 and a cartridge stem 61 (see FIG. 7). For example, cooperating means (not shown) on the handle stem and cartridge stem may provide a clipped, sprung-loaded connection which can be unclipped using a moving part (not shown) which is contacted by the user to attach and/or detach the handle body and cartridge.

FIGS. 4 and 5 show the cartridge footprint on the user's skin, with its parallel sides and rounded edges to each end of the blades. The area of the footprint can be measured by projecting the skin-contacting edges of the cartridge onto a flat plane.

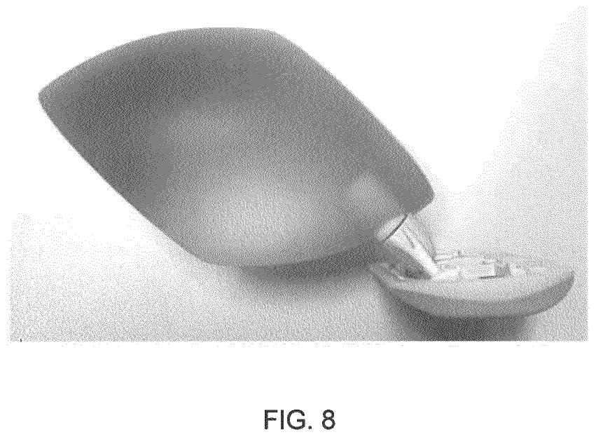

The handle body is made entirely from a translucent silicone or TPE-SEBS in this embodiment, as can be seen better in FIG. 8. The material is translucent and light coloured, so light can easily transmit through it. The translucent material is not only attractive but also practical in allowing parts behind the body to be glimpsed through the body and thus aiding user orientation and shaving performance. The surface looks and feels silky and non-sticky to the hands of the user. FIG. 8 also reveals the extension of the handle stem 59 into the body. The stem and any other interface part may be made of a harder plastic, such as PPA/PPS/LCP or ABS.

The handle body may be formed by either LSR or injection or compression moulding. The full razor may weigh around 40 to 60 grams, preferably around 55 grams and the handle body may have a Shore A hardness of approximately 10 to 50, preferably 15 to 40 or around 20, to give a squeezable feel and pleasurable tactile sensation when gripped by the user. It may include a logo on the front surface (the further end surface which is on the top when the razor is in the upright position).

The stem may be fixedly connected to the handle body, such as by chemical connection.

In other embodiments, the handle body may have a hollow or solid insert (such as a core) of another material. If there is a hollow insert, it may store a fluid, such as a shaving preparation. In this case, the stem between the cartridge and handle body may include a fluid passage for a shaving preparation dispensed from within the body and the body may include a dispensing aperture.

The cartridge of these figures may include a lubricating strip or wider lubrapad 12 (not shown) as an additional or integral part of the cartridge, for example with a single frame both surrounding the blades and providing a back support for the lubrapad. The end surface has been shown and described as flat, but may alternatively be curved or uneven, if there is no requirement for the razor to be stable in an upright position.

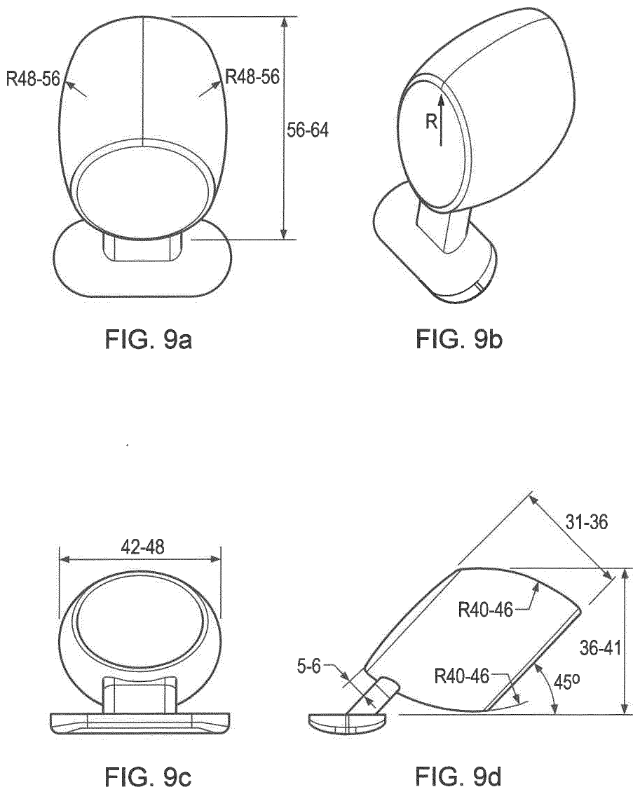

Some advantageous dimensions of the safety razor which give good manoeuvrability in the human hand are shown in FIGS. 9a, 9b, 9c and 9d. The maximum radius of curvature of the “skewed barrel shape” side surface may range between 35 and 75 mm, preferably 48 and 56 mm, for example 53 mm. The radius of curvature of the skewed barrel shape at the barrel ends is between 30 and 55 mm, preferably between 40 and 46 mm, for example 44 mm. The radius of the flat surfaces (measured along the surfaces, rather than perpendicular to the barrel surface) is slightly smaller.

The maximum length of the handle body parallel to the skin surface in use (with the end surface at 45° to the skin surface) is from 40 to 80 mm, preferably between 56 and 64 mm, for example 61 mm. This is measured from the foremost extent of the front (the lowest portion of the front or further end surface) to the rearmost extent of the rear (the highest portion of the rear or end surface which rests on the horizontal plane when the razor is upright). The maximum height of the handle body in use is between 25 and 55 mm, preferably between 36 and 41 mm, for example 39 mm.

The distance between the end surfaces is between 25 and 45 mm, preferably between 31 and 36 mm, for example 35 mm. The handle stem (or other interface between the handle and cartridge) starts at 3 to 10, preferably 5 to 6 mm along the underneath portion of the side surface in use from the front surface. The maximum width of the handle body measured parallel to the end surfaces is between 35 and 60 mm, preferably between 42 and 48 mm, for example 46 mm.

If the cartridge is flat on the skin in use, the end surfaces extend at between 35 to 55, preferably at 45 degrees to the skin surface.

The cartridge footprint may have a length of around 25-60 mm in the blade direction, preferably around 40-50 mm and a depth orthogonal to the blade direction from the front to the rear of the cartridge of around 10-30 mm, preferably 15-23 mm. Whilst the cartridge size may have a natural maximum linked to its function, the handle body and in particular the handle body extent in the blade direction is not similarly limited.

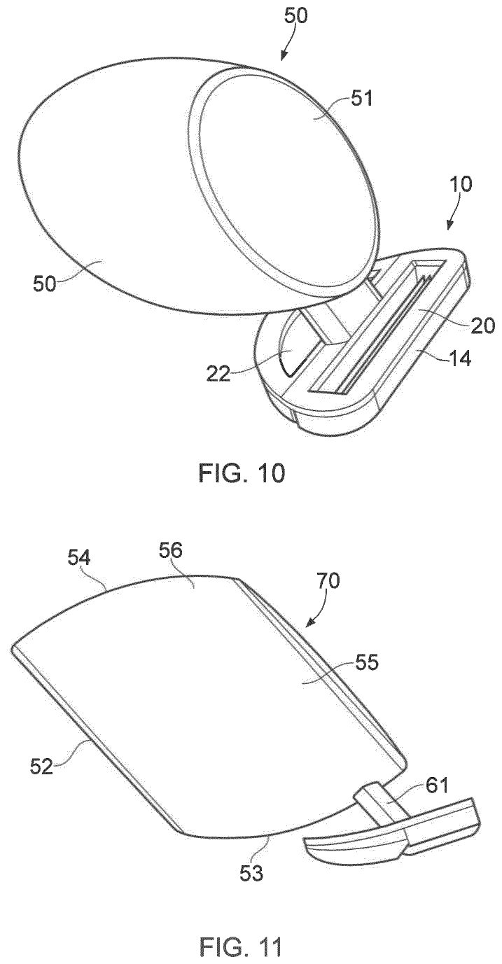

FIGS. 10 to 15 show slightly different cartridge construction, but the same general handle body shape, with like reference numerals labelling the same parts as for FIGS. 1 to 9. Therefore, the reader is directed to the previous description thereof.

FIGS. 10 to 15 show lubrapad 12, and blades 16 in the blade housing 14. The cartridge 10 of these figures includes the lubrapad 12 as an integral part, with a single frame surrounding the blades and providing a back support for the lubrapad.

In an alternative definition which can be applied to these figures and the earlier and later figures, some embodiments of the invention provide a safety razor handle comprising: an underneath surface portion 53 facing the skin of the user in use and comprising an attachment means (such as a stem) for attachment to a blade unit; a front surface portion 51 facing in the opposite direction from the shaving direction in use; a rear surface portion 52 facing in the shaving direction in use; a top surface portion 54 and lateral surface portions 55, one directed to either side of the blade length in use; wherein the top surface portion, underneath surface portion and side surface portions together form a continuous smooth surface which is a substantially cylindrical or substantially ellipsoid or substantially partially spherical surface; and wherein: the distance between the front surface portion and rear surface portion is between one third and three times, preferably between a half and twice, the largest dimension of the largest cross section through the continuous smooth surface.

The term substantially cylindrical or substantially ellipsoid or substantially partially spherical surface is used to describe a shape which is close to cylindrical or ellipsoid or partially spherical form, for example with a 10% deviation from one of those forms. In one measure, a section (or all sections) taken vertically through the continuous smooth surface (for example in a direction parallel to the blade length) overlaps with a circle or ellipse drawn to just cover the whole section with the areas of the circle or ellipse which are not covered by the section being up to one tenth of the area of the section.

The front and rear surface portions may be flat or concave. The front surface may extend to the guard side of the attachment to the blade unit, and may conveniently be provided with a logo and/or instructions. It may extend substantially parallel to the rear surface portion and preferably substantially parallel to a main direction (in terms of longest extent) of the stem.

In another embodiment the body is hollow and contains a shaving preparation, which, for example, can be squeezed out by the user via the attachment means to the blade unit. Thus the shaving preparation (which may contain lubricating and/or hair conditioner and/or moisturiser) may pass through the recess, for example within a part of the blade unit which is housed inside the recess.

In one razor embodiment, the attachment means for attachment to the blade unit and corresponding means on the blade unit allow relative movement, such as pivoting movement, between the handle and the blade unit. For example the connection between the corresponding means and attachment means may have some play, or one or both of the attachment means or corresponding means may be flexible.

In one embodiment the corresponding means is a stem extending from the blade unit to the handle. The stem may fit into the recess, permanently or detachably.

In a further embodiment, the razor comprises a hard shell extending from the stem and forming part of the handle. The hard shell may give additional support to the body and a enable an enhanced connection to the blade unit.

In one embodiment either the stem or the shell is provided with a spigot (outlet for fluid connection from the body) which extends into the handle, to transport shaving preparation.

In one embodiment the shell forms the rear surface portion and part of the underneath and side surface portions of the handle. In this case, the shell may fit over the elastomeric material (such as TPE, rubber or silicone) body described previously. It may fit into receded surface portions of the body, so that the combination of the shell and the body provides a smooth external surface.

In one embodiment the safety razor further comprises a lubrapad. For example, a lubrapad body may be provided adjacent to the blade unit, and extend along a guard of the blade unit and in front of the guard in use. The lubrapad body may have a greatest width and/or depth in the blade direction at the guard, the body width and/or depth reducing in a smooth convex curve away from the guard to a curved front portion of the body.

In one embodiment the lubrapad body and cartridge are provided separately and comprise attachment means to attach them together whilst allowing relative movement, such as flexible projections from a front surface of the guard, which are to be housed in recesses in a surface portion of the lubrapad body which is directly facing the guard front surface.

In a further definition of the handle, invention embodiments provide a safety razor handle comprising a moulded translucent or transparent body of elastomeric material such as TPE, silicone or rubber having a Shore A hardness of 5 to 65 or preferably 10 to 50; wherein the body has a shape which is rounded and chunky (or bulbous), extending with perpendicular length l, width w and height h, wherein none of the maximum length, width and height of the body is more than 2, 3 or 4 times the size of the maximum in the other two dimensions.

For example, the height may be the largest vertical cross section through the side smooth surface previously defined, the width may be the largest horizontal cross section through the side surface and the length may be the horizontal distance (parallel with the shaving plane) between the end surfaces.

Any of the previous features of the handle and safety razor (and safety razor system) may be applied to these embodiments.

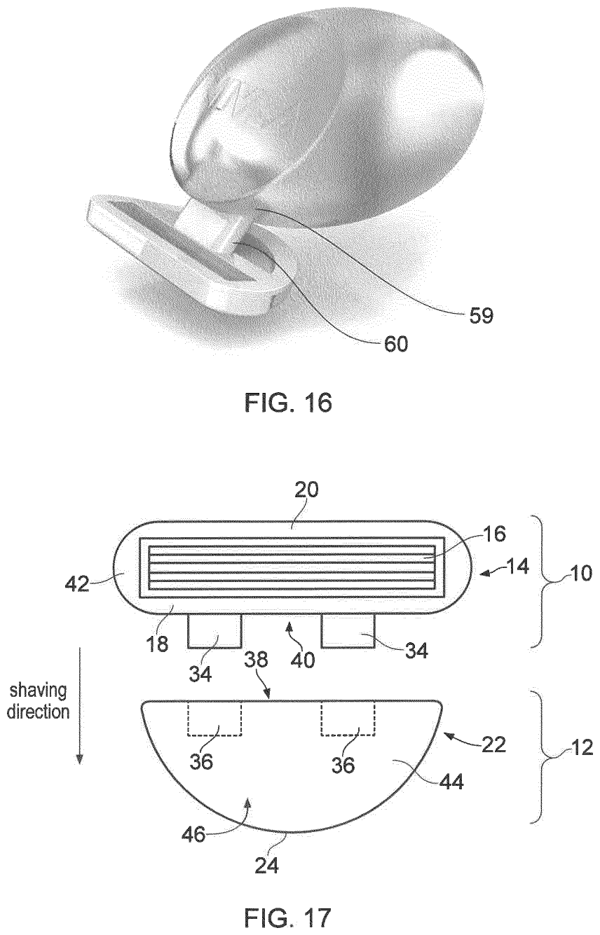

FIG. 16 shows a safety razor with the cartridge construction of FIGS. 10 to 15 and made of a translucent silicone or TPE. This razor has a non-flat “dished” (gently concave) front surface with an embossed logo.

FIG. 17 shows a different lubrapad and cartridge which may be used with the handle. The lubrapad 12 comprises a lubrapad body 22 comprising solid lubricating material. The lubrapad body 22 has a first surface portion 38 which directly faces a front surface 40 of the guard 18, a second (bottom, gliding or skin-contacting) surface portion 44 adjacent to the skin-contacting side of the cartridge 10, and a third (top) surface portion 46 generally opposite the second surface portion 44. In use, the second surface portion 44 lubricates the skin of a user and the third surface portion 46 is directed away from the skin of the user towards the handle body 50. The first, second and third surface portions 38, 44, 46 of the lubrapad body 22 generally define a wedge having a curved front portion (semi-circular or partially semi-circular edge) 24 with the second surface portion 44 curving towards the curved front portion 24. The second surface portion 44 can be continuously curved toward the front portion 24 or can include a flat portion before curving towards the front portion 24. The greatest length of the third surface portion 46 in the shaving direction can be at least twice or three or four times the height of the first surface portion 38 in a direction perpendicular to the shaving plane.

FIG. 17 shows the cartridge 10 and the lubrapad 12 from underneath and separated from one another for greater clarity. As shown, the cartridge 10 has projections 34 extending from a front surface 40 of the guard 18. (The reader should recall that “front” means facing the shaving direction.) When the blade housing 10 and the lubrapad 12 are joined together, the projections 34 are (at least partly) housed in recesses 36 in a surface portion 38 of the lubrapad 22 which is directly facing the front surface 40 of the guard 18. For simplicity, the projections 34 and recess 36 are shown as rectangular in shape. These can be friction fit, threaded, glued, overmolded, or otherwise secured together. Other types of projections, for example spikes, hooks or any other suitable shapes, can be provided alternatively.

The smooth/continuous reduction of the width and depth of this lubrapad and the convex form of the gliding surface allows improved gliding across the skin of a user, with provision of the most lubrication closest to the blades.

Separating the cartridge and lubrapad, so that they can move independently from one another, allows the cutting and lubricating functions to be separated, and that allows optimization of the cartridge and lubrapad design to conform to, or follow, the contours of a user's skin. The term lubrapad' generally refers to a solid shaving aid that has lubricating properties. The lubrapad can, of course, have other properties considered beneficial during shaving such as, for example, moisturizing properties. The lubrapad can be provided ‘bare’ in that it is not contained or surrounded by any manner of housing, base, or holder. Furthermore, the lubrapad body can consist entirely of solid lubricating material or the lubricating material can form part of the body, such as a layer on the body.

The composition of the lubrapads described herein can include a gliding agent. Materials which may be selected as the gliding agent are: PEG-400/1,4-Butanediol/SMDI Copolymer, PEG-115M, PEG 45M, and PEG-5M, or a combination thereof. The composition of the lubrapad can include an antioxidant agent, for example Tocopherol. The composition of the lubrapad can include an anti-inflammatory agent, for example aloe barbadensis leaf juice. The composition of the lubrapad can include a backbone structure. Materials which may be selected as the backbone structure are: styrenic block copolymers and polystyrene, or a combination thereof.

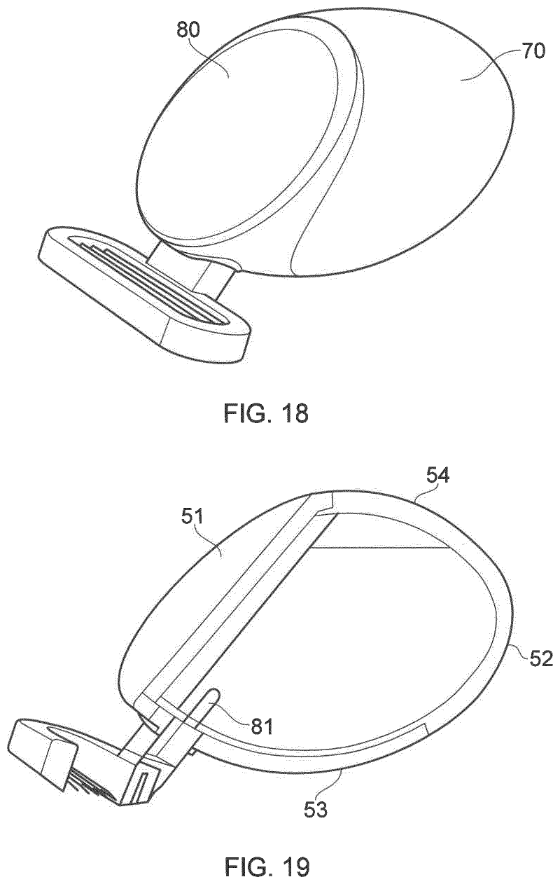

FIGS. 18 to 20 show another safety razor 100 which generally has the same construction/shape as that shown in FIGS. 1 to 17 (with like reference numbers denoting like features). Here there is an additional hard shell and no lubrapad (of course a lubrapad according to either of the previous descriptions or any other lubrapad could be added).

The handle 50 includes a hard curved shell 80 and the soft/medium soft silicone/TPE-SEBS body 70. The hard shell is provided at the front of the razor (closest to the cap) and forms the slanted front surface portion. It also curves to form part of the underneath surface portion. Where it joins the soft body, the body is shaped with receded portions 82 to give a smooth continuous external curved surface.

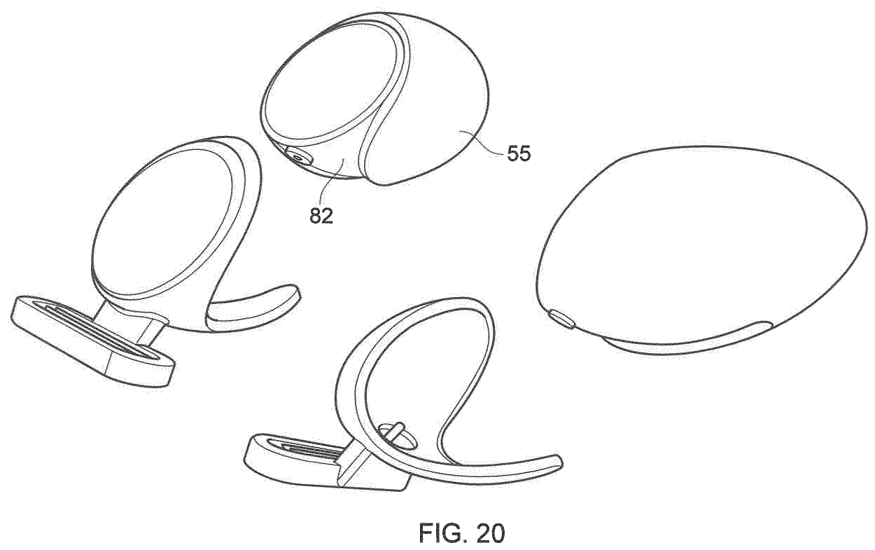

The shell is formed integrally with the stem 61 of the cartridge and the cartridge, but is detachable from the body 70. FIGS. 19 and 20 show the spigot 81 allowing flow of shaving preparation from the hollow body and the dispensing aperture 83.

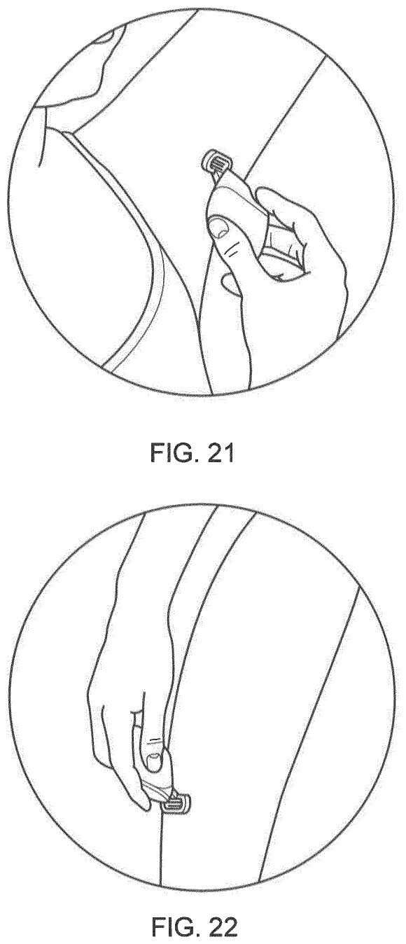

FIGS. 21 and 22 show a razor including a hard shell in use, demonstrating how its chunky form fits well into the human hand, with possible positioning of the forefinger on the hard shell.

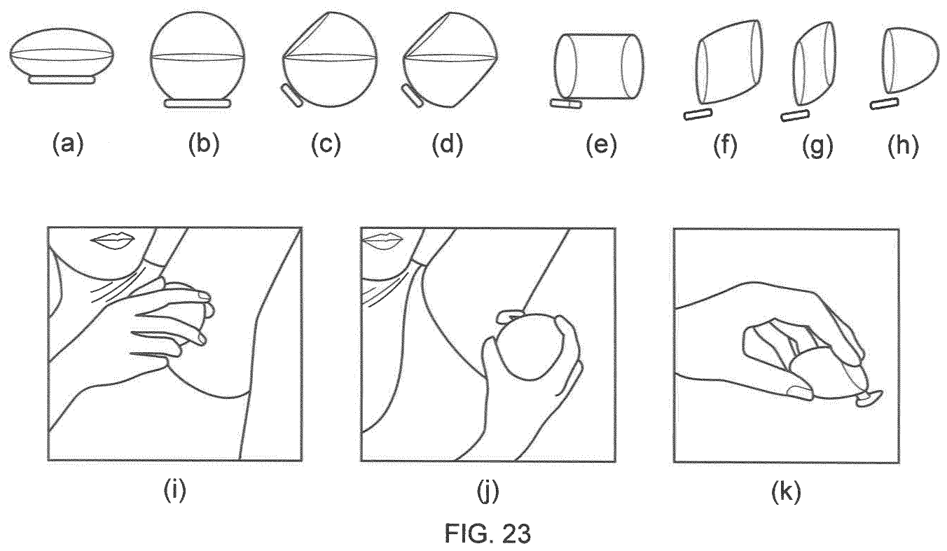

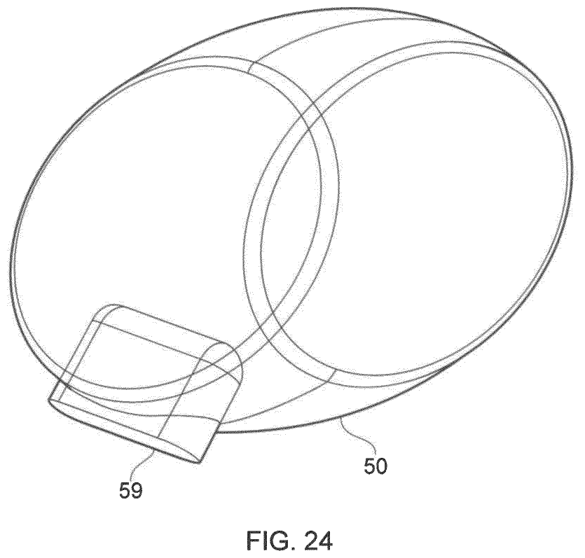

FIGS. 23a to 23h show alternative shapes of a safety razor. In each case, the cartridge is simply represented in side view as a rounded rectangle and the handle body shape provided also in side view. The skilled reader will appreciate that any kind of suitable connection, whether releasable or fixed, may be provided between the cartridge and handle body.

FIG. 23a shows an elliptical cross-section handle body, with the cartridge attached to the underneath side in use, preferably off-centre, approximately perpendicular to the vertical rotation axis.

FIG. 23b shows a spherical handle body with a cartridge attached to it off-centre in the sense that the assumed stem direction is not parallel to the radius direction.

FIG. 23c shows a part-spherical handle body with a cut-off plane orthogonal to the axis connecting the centre of the plane to the centre of the handle body, with a cartridge attached off-centre to the part-spherical surface.

FIG. 23d shows a part spherical handle body with two parallel cut-off planes, each orthogonal to the axis connecting the centre of the plane to the centre of the handle body, with a cartridge attached off-centre to the part-spherical surface.

The handle bodies in FIGS. 23b to 23d are as big as or bigger than the handle bodies with the dimensions mentioned earlier.

FIG. 23e shows a cylindrical handle body with a cartridge attachable to one side towards the end of the handle body.

FIGS. 23f and 23g show different proportions of the skewed barrel shape previously described, with a longer barrel axis and a shorter barrel axis.

FIG. 23h shows a handle body with a front flat surface and continuously curved side and rear portion, with the cartridge attached to the curved side portion.

FIGS. 23i, 23j and 23k show a razor in use, demonstrating how its chunky form fits well into the human hand.

FIG. 24 shows a safety razor handle in perspective view and is drawn to illustrate the translucent nature of the handle body: the far edges of the handle body are visible through the handle body. The handle stem 59 acting as a cartridge attachment is not translucent and can be seen extending from inside the handle body to outside the handle body and parallel to the end surface. If the handle body rests on the flat end surface 52 which can be glimpsed through the body, the cartridge attachment is elevated above any plane supporting the handle body, as is any cartridge attached to it.

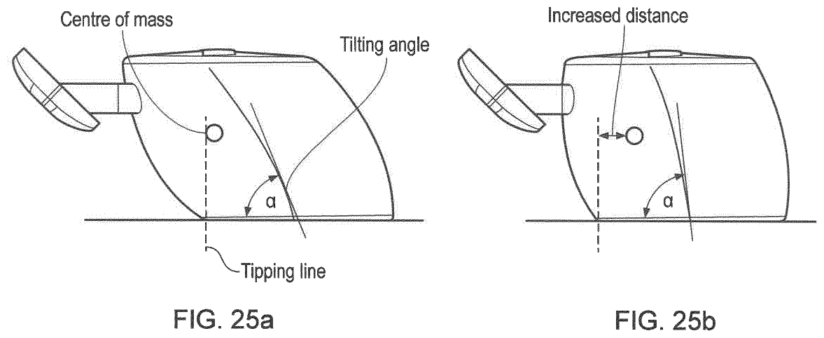

FIG. 25a is a side view of the handle body in upright position showing a centre of mass. Due to the slanted design of the body, the centre of total mass (including the removable cartridge and any protection cap on the cartridge) is to the non-overhand side but close to a tipping line passing through the front edge of the body, and about which body can topple forwards. The closer the centre of mass to the tipping line, the less securely the body rests on its end surface. A curved axis of the body orthogonal to the two flat ends is included as a dashed line. A tilting angle a is shown between the axis of the barrel shape at the end surface and the end surface.

FIG. 25b is a side view of a handle body with a lesser slant. Thus the centre of mass is further from the tipping line, the axis of the body is closer to the vertical at the underneath end surface and the angle a between the axis of the barrel shape at the end surface and the end surface is closer to 90%. This increases the standing stability.

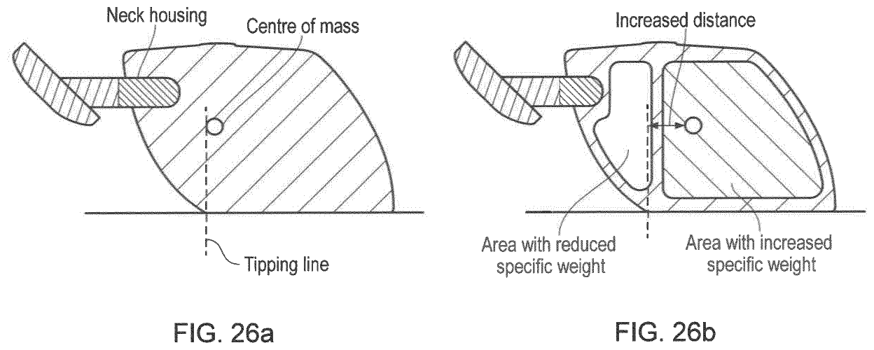

FIG. 26a again shows the safety razor in the upright position with a slanted construction, and differs from FIG. 25a only in that it is a cross section and indicates different construction materials using shading, with a neck housing of a different material from the cartridge. FIG. 26b shows a safety razor in the upright position with the same slanted construction but a lower density/specific weight area in the front of the razor than in the rear of the razor. That is, the material of the handle body on the same side of the centre of mass as the overhang is less dense than the material of the handle body to the other side of the centre of mass from the overhang. A reduced specific weight (at the front of the handle body) may be by use of air, foam or lightweight solid materials, either as a separate part or connected to the neck housing.

An increased specific weight to the rear (non-overhang side) in the upright position may be achieved by holding liquid such as water or shaving/cleaning emulsions within the handle body.

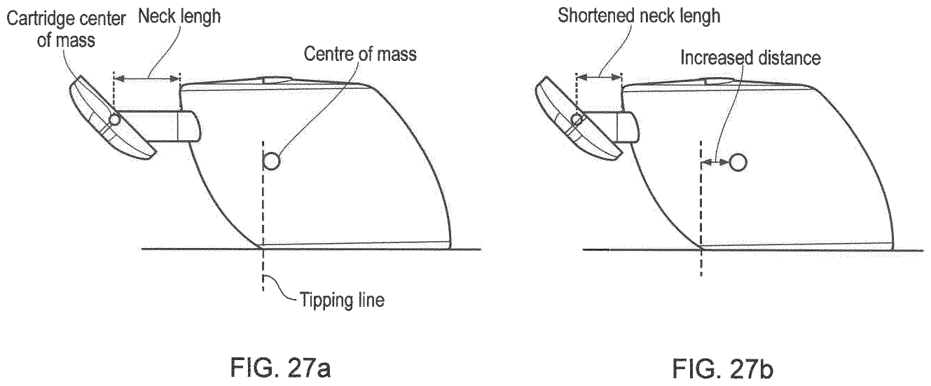

FIG. 27a shows the safety razor of FIG. 25a in the upright position with a slanted construction and indicates a cartridge stem/neck length and a cartridge centre of mass. The centre of mass of the combined body and cartridge is shown close to the tipping line. FIG. 27b shows the same safety razor in the upright position but with a shorter cartridge neck/stem than in FIG. 27a. This increases the standing stability, moving the centre of mass further backwards away from the tipping line. The same effect can be achieved by reducing the weight of the cartridge.

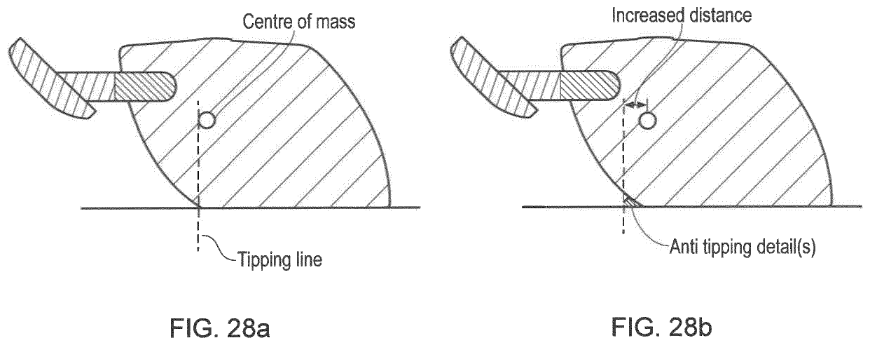

FIG. 28a shows the safety razor of FIG. 26a in cross section in the upright position with a slanted construction and FIG. 28b shows the same safety razor in cross section in the upright position with a slanted construction but with an anti-tipping detail. This is a small part which moves the tipping line away from the centre of mass by virtue of an additional extent of the flat surface, for example a lip. The anti-tipping detail may be part of the basic handle design or a minimised separate shape/form which does not detract from the design intent of the handle.

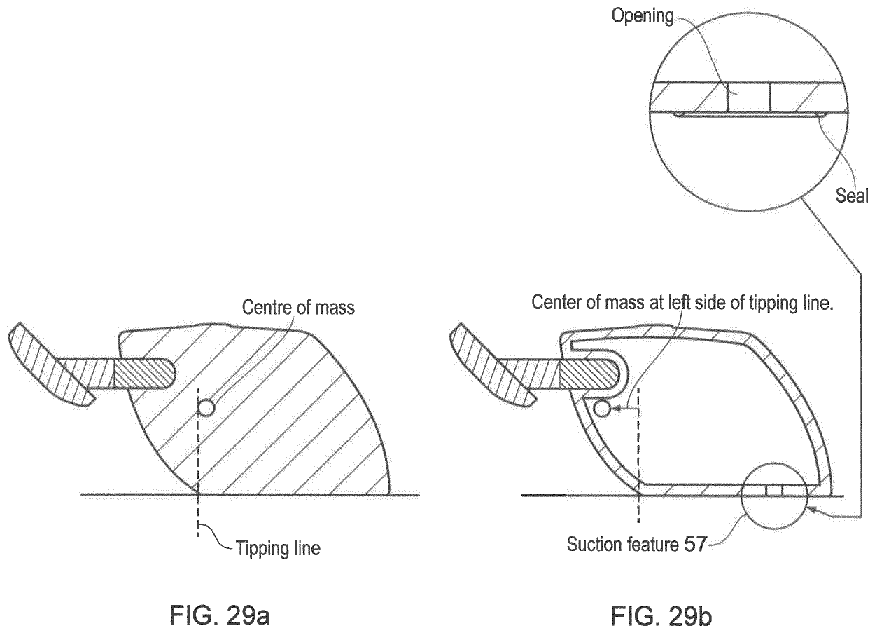

FIG. 29a shows the safety razor of FIG. 26a in cross section in the upright position with a slanted construction and FIG. 29b shows a hollow safety razor in cross section in the upright position with a slanted construction and a suction feature.

Due to the tilted design of the handle (see FIG. 29a) the centre of the total mass (including the removable cartridge and any protection cap) is very close to the tipping line. It may even be to the left (overhand side) of the tipping line (e.g. in case of a hollow handle), thus making it tip over.

The standing functionality is improved or safeguarded by adding a suction feature 57 on the right side of the tipping line (see example B). This suction feature comprises an air opening and an elastic seal rim located around the opening in a hollow (or partially hollow) squeezable elastic handle (to create an under pressure). The suction feature might also be used for other reasons, such as hanging from a vertical wall, or refilling the handle by sucking up shaving/cleaning liquids or foam. It could also feature a valve to prevent leakage in case a refilling functionality is used.

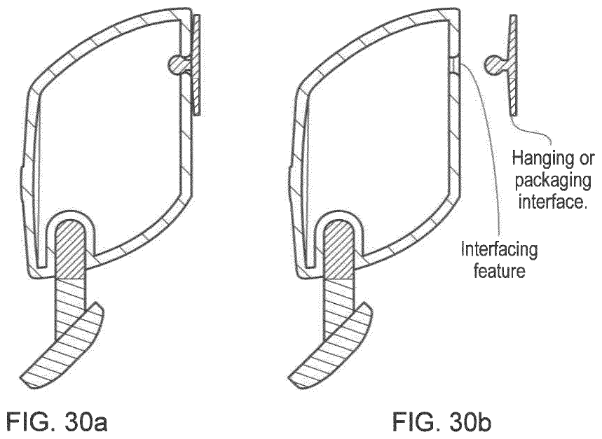

FIG. 30a shows a safety razor in cross section in a hanging position, suspended from a knob on a vertical plane. FIG. 30b shows the safety razor and knob separately. The handle shown has an interfacing feature in the form of a recess or opening 58 on the flat end surface, to connect the handle to something other than the cartridge. The handle is shown as hollow but may be solid or only partially hollow. For instance, the interfacing feature may connect to packaging, a travel case, a multi cartridge holder or a hanging interface (such as the knob shown) which can be glued or connected by a suction cup to a surface, enabling the user to place it in a convenient location in the bathroom or shower.

This interfacing feature could also be a means to mechanically connect and seal the handle to a refill application (for instance a squeeze bottle) enabling an easy refill with shaving or cleaning liquid/foam inside of the handle. In this case a further opening in the handle might be required to allow the passage of air.

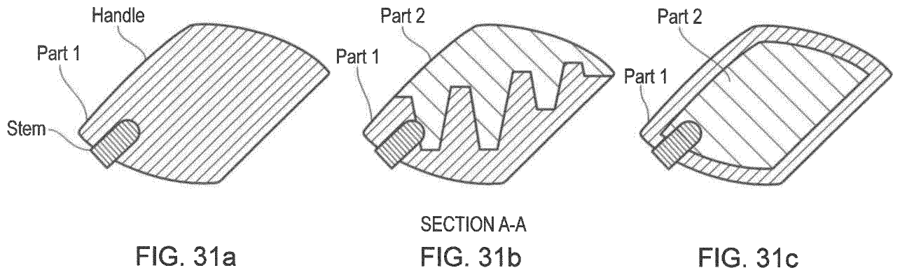

FIGS. 31a, 31b and 31c show three different manufacturing options.

The handle body can be made of one or multiple parts or part combinations and/or have different materials and/or material combinations. The different parts and materials could introduced from a design perspective and/or have economic and/or functional reasons. The handle may be fabricated from the following materials: thermoplastic elastomers/thermoplastics/thermoset/silicones/metals/ceramics/natural materials (like wood or stone)/glass or composites. These materials can have different colouring, be opaque, translucent or transparent

The outside of the handle body could be separately fabricated from lacquers or coated with different materials to improve design or functionality.

The handle can be manufactured in different ways. Plastics can be fabricated by casting/injection moulding/compression moulding/milling/stamping/etc. The handle body can be manufactured all at once in one piece (as shown in FIG. 31a) or by dividing the handle into multiple sections which are fabricated individually and combined or connected later during fabrication or by the user. Because the handle has a thick roundish shape it is difficult to injection mould this part without visual imperfections in an affordable way. For this reason the handle might be split up in different parts which have a thinner wall thickness compared to the final shape and are joined to give a smooth continuous external curved surface. FIGS. 31b and c show different options to enable this. In FIG. 31b, two opposite halves are castellated at their internal join. An upper part (in the in-use position) has one or more peaks and troughs. These may extend in a direction perpendicular or parallel to the two opposite surfaces. The lower part has the opposite configuration of troughs or peaks so that the two parts together form a solid hole with no gaps. The lower part may form the entire rear flat end surface. A neck insert may be integral with the lower part, or separately provided. In FIG. 31c, a core is surrounded by an external layer, which may be, for example of an even thickness of between one tenth and one half, preferably around one sixth of the extent of the core as shown in the diagram in cross section. In the first stage of the injection moulding process part 1 is moulded. In a second stage part 2 is added and together they form a solid handle body with individual parts that cannot be distinguished from each other by the user.

In each case, the stem of the handle or neck housing for connection to the cartridge is shown as a separate piece. However, the stem may be of the same material as and/or integrally formed with either of part 1 and part 2. In one advantageously simple and elegant construction, the core and stem (for example as shown in FIG. 31c) are integrally formed of the same material.

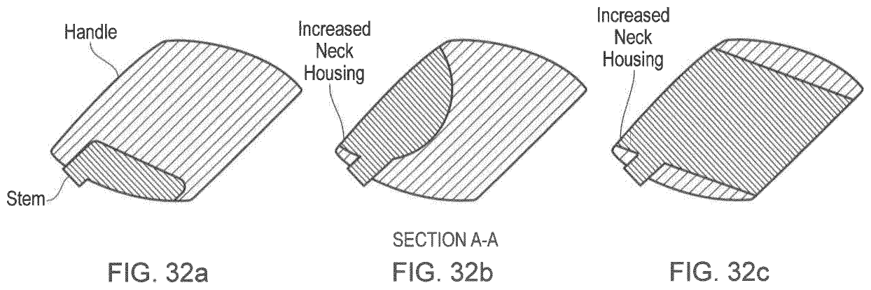

FIGS. 32a, 32b and 32c show three different cross sections of a handle with the same external shape made with three different inserts. In order to simplify the manufacturing/reduce the complexity or costs and/or hide technical details of a cartridge release mechanism, add functionality and/or improve the design, a stem part size might be increased to form a big solid opaque, translucent or transparent piece which is part of the handle design. FIG. 32a shows an increased stem part which can facilitate incorporation of a cartridge release knob at the bottom on the underneath side of the razor in use. FIG. 32b shows an increased neck housing which may be used for increased design exposure of a brand logo on the front side in use. FIG. 32c shows a way to reduce manufacturing complexity of the handle using a centre core which can be supported from two opposite sides in the mould.

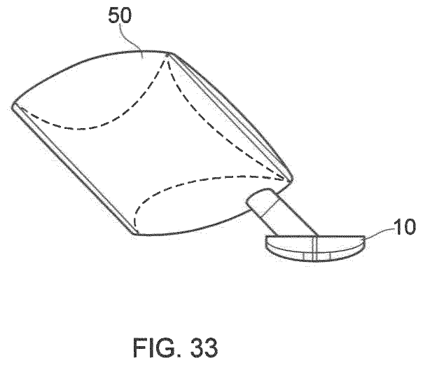

FIG. 33 shows a side view of a safety razor in a use position with shaping and an internal core shown in dashed lines. Here, the opposite end surface (the front of the razor) has a dished surface. The core extends from the dished surface to the flat end surface in a complex form which narrows at its centre and expands to the opposite surfaces.

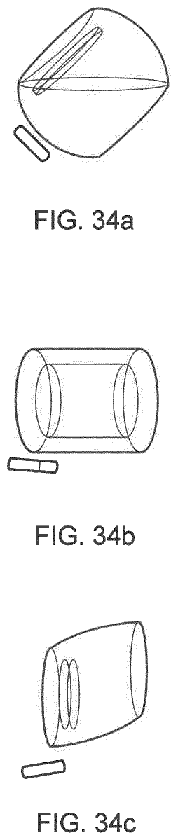

FIGS. 34a, 34b and 34c are schematic diagrams of safety razors in side view showing options for embedding logos. In each case, the cartridge is simply represented in side view as a rounded rectangle and the handle body shape provided also in side view. The skilled reader will appreciate that any kind of suitable connection, whether releasable or fixed, may be provided between the cartridge and handle body. In FIG. 34a, the handle body is symmetrically barrel shaped between two flat end surfaces; in FIG. 34b, the handle body is cylindrical and in FIG. 34c the handle body is a slanted barrel shape.

In each case, the outer handle body is translucent and a cylindrical insert (for example of a different material) is used to display a logo. The insert may be of a depth which is much smaller than its diameter (a coin-shaped insert) or it may be of a depth which is equal or greater than the diameter. The logo may be a physical part of the insert and be protruded or recessed. Additionally or alternatively, it may be printed or lacquered or given a surface texture or finish which distinguishes it from the insert.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

### REFERENCE NUMBERS

10 cartridge

12 lubrapad

14 blade housing

16 blades

18 guard

20 cap

22 lubrapad body

24 front portion (of the lubrapad body)

34 projections

36 recesses

38 first surface portion (of the lubrapad body)

40 front surface (of the guard)

42 rounded side portions (of the cartridge)

44 second surface portion (of the lubrapad body)

46 third surface portion (of the lubrapad body)

50 handle body

51 front surface portion or opposite end surface

52 rear surface portion or flat end surface

53 underneath surface portion

54 top surface portion

55 lateral surface portion

56 continuous side surface

57 suction feature

58 handle body recess

59 handle stem/cartridge attachment means

61 cartridge stem

70 moulded body

80 hard shell

81 spigot

82 receded portions of body

83 dispensing aperture

100 safety razor or safety razor system

1.-15. (canceled)

16. A safety razor handle, wherein the handle comprises a handle body and a cartridge attachment element; the handle body being bulbous in two orthogonal directions, widening away from a first end surface towards a center of the body.

17. The handle of claim 16, wherein the handle further comprises a second end surface opposite to the first end surface, the two opposite surfaces being connected by a side surface which widens towards the center of the body.

18. The handle of claim 17, wherein there is a single continuous side surface between the two end surfaces.

19. The handle of claim 18, wherein the second end surface is a front end surface facing in an opposite direction to a shaving direction in use and the first end surface is a rear end surface facing in the shaving direction in use, the cartridge attachment element being on a continuous curved side surface closer to the front end surface than to the rear end surface.

20. The handle of claim 16, wherein one or both of the first and second end surfaces are flat.

21. The handle of claim 20, wherein the first and second end surfaces are parallel.

22. The handle of claim 16, wherein the handle body is in the form of a slanted barrel shape, with a skewed barrel surface between two end surfaces.

23. The handle of claim 22, wherein the first and second end surfaces are in a vertical orientation, with the cartridge attachment extending downwards, the barrel surface being skewed upwards from the front end surface towards the rear end surface.

24. The handle of claim 22, wherein the barrel shape has a substantially circular or substantially elliptical cross section perpendicular to its longitudinal axis and widens continuously from its two end surfaces towards the center.

25. The handle of claim 23, wherein the barrel shape has a substantially circular or substantially elliptical cross section perpendicular to its longitudinal axis and widens continuously from its two end surfaces towards the center.

26. The handle of claim 22, wherein a largest diameter of the barrel shape is between a third and three times a length of a longitudinal axis of the barrel.

27. The handle of claim 22, wherein a largest diameter of the barrel shape is between a half and twice a length of a longitudinal axis of the barrel.

28. The handle of claim 22, wherein a largest diameter of the barrel shape is larger than a length of a longitudinal axis of the barrel.

29. The handle of claim 16, wherein the cartridge attachment element is in the form of a stem, which connects the cartridge and the handle body.

30. The handle of claim 29, wherein the cartridge attachment element extends from a side surface.

31. The handle of claim 16, wherein the first end surface comprises an interface to allow external attachment of the safety razor.

32. The handle of claim 16, wherein the handle body is made of two or more parts which are fabricated individually.

33. The handle of claim 31, wherein the cartridge attachment element and part of the handle body are fabricated from one part and a rest of the handle body is fabricated from another part.

34. The handle of claim 16, wherein the handle body includes an insert inside a translucent material of the handle body.

35. A safety razor, wherein the razor comprises the handle of claim 16 and a cartridge.
